(19) United States
(12) Patent Application Publication
(10) Pub. No.: US 2012/0164513 A1
(43) Pub. Date: Jun. 28, 2012

(54) BATTERY SEPARATOR AND METHOD FOR MANUFACTURING THE SAME

(75) Inventors: Yu Min Peng, Hsinchu City (TW); Jing-Pin Pan, Hsinchu Hsien (TW); Tsung-Hsiung Wang, Taichung County (TW); Chang-Rung Yang, Taichung County (TW)

(73) Assignee: INDUSTRIAL TECHNOLOGY RESEARCH INSTITUTE, Hsinchu County (TW)

(21) Appl. No.: 13/235,407

(22) Filed: Sep. 18, 2011

(30) Foreign Application Priority Data
Dec. 22, 2010 (TW) 099145167

(51) Int. Cl. H01M 2/16; B05D 5/12; C08L 79/04

(52) U.S. Cl. 429/144; 429/249; 521/138; 521/139; 521/134; 427/77

(57) ABSTRACT

The present discloser provides a battery separator, including: a porous hyper-branched polymer which undergoes a closed-pore mechanism at a field effect condition, wherein the field effect condition includes at least one of a temperature being above 150° C., a voltage being 20V, or a current being 6 A; and a porous structure material. The invention also provides a method for manufacturing the battery separator and a secondary battery having the battery separator.

### CROSS REFERENCE TO RELATED APPLICATIONS

This Application claims priority of Taiwan Patent Application No. 099145167, filed on Dec. 22, 2010, the entirety of which is incorporated by reference herein.

### BACKGROUND OF THE INVENTION

1. Field of the Invention

The present invention relates to a battery separator and a method for manufacturing thereof.

2. Description of the Related Art

Due to the development of the electronics industry, batteries are broadly applied to all kinds of products, such as mobile phones, digital cameras, laptops, or even electronic vehicles. Therefore, demand for batteries has continuously increased. In addition to pursuing higher battery performance, safety of batteries has attracted great attention recently.

A typical battery mainly includes electrodes, electrolyte, and a separator. Ions formed at an electrode are transported in the electrolyte to form a current, such that chemical energy is transformed to electrical energy. A lithium battery as one of a main power source of electronic vehicles due to its high energy density. However, as energy density of a battery increases, output power and battery size may increase as well, resulting in a greater amount of heat during operation. Without an effective way to dissipate the heat, the battery temperature may increase, even resulting in an explosion. Therefore, ensuring the safety of the battery has become more and more important.

Battery separator plays an important role in a lithium battery. A battery separator is disposed between two electrodes, preventing physical contact between the two electrodes, thus improving the safety of the battery. It is therefore desirable to provide a battery separator having high porosity, good heat resistance, and a field effect mechanism.

### BRIEF SUMMARY OF THE INVENTION

An embodiment of the invention provides a battery separator, including: a porous hyper-branched polymer which undergoes a closed-pore mechanism at a field effect condition, wherein the field effect condition includes at least one of a temperature being above 150° C., a voltage being 20V, or a current being 6 A; and a porous structure material.

Another embodiment of the invention provides a method for manufacturing a battery separator, including: providing a porous structure film; and coating a porous hyper-branched polymer onto the porous structure film to form a battery separator, wherein the battery separator includes the porous hyper-branched polymer undergoing a closed-pore mechanism at a field effect condition, wherein the field effect condition includes at least one of a temperature being above 150° C., a voltage being 20V, or a current being 6 A.

Another embodiment of the invention provides a method for manufacturing a battery separator, including: mixing a porous structure material and a porous hyper-branched polymer to form a mixture; and subjecting the mixture to a dry or wet process to form a battery separator, wherein the battery separator includes the porous hyper-branched polymer undergoing a closed-pore mechanism at a field effect condition, wherein the field effect condition includes at least one of a temperature being above 150° C., a voltage being 20V, or a current being 6 A.

Another embodiment of the invention provides a secondary battery, including: a cathode and an anode; an electrolyte between the cathode and the anode; and the previously described battery separator disposed between the cathode and the anode to separate the cathode and the anode.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart of manufacturing a battery separator according to one embodiment of the invention.

FIG. 2 is a flow chart of manufacturing a battery separator according to another embodiment of the invention.

FIG. 3 illustrates a secondary battery formed in one embodiment of the invention.

FIG. 4 illustrates free volume of the hyper-branched polymer at various temperatures according to one example.

FIG. 5 illustrates a coating process performed by sinking according to one example.

FIG. 6 illustrates a coating process performed by in situ synthesis according to one example.

FIGS. 7A-7B is a SEM diagram of a separator according to a comparative example.

FIGS. 8A-8B is a SEM diagram of a separator before and after a pressing process according to one example.

FIGS. 9A-9E is a TGA diagram of formed polymer according to one example.

### DETAILED DESCRIPTION OF THE INVENTION

The following description includes embodiments of carrying out the invention. This description is made for the purpose of illustrating the general principles of the invention and should not be taken in a limiting sense. The scope of the invention is best determined by reference to the appended claims.

Moreover, the formation of a first feature over and on a second feature in the description that follows may include embodiments in which the first and second features are formed in direct contact, and may also include embodiments in which additional features may be formed between the first and second features, such that the first and second features may not be in direct contact.

In one embodiment of the invention, a porous hyper-branched polymer is provided. The porous hyper-branched polymer undergoes a closed-pore mechanism at a field effect condition, wherein the field effect condition includes at least one of a temperature being above 150° C., a voltage being 20V, or a current being 6 A. Therefore, the porous hyper-branched polymer may be applied to a battery separator. The battery separator formed of the porous hyper-branched polymer has a pore size of between about 0.2 nm and 500 nm, preferably between about 0.3 nm and 300 nm. The battery separator has a porosity of between about 10% and 80%, preferably between about 30% and 60%. When the pore size shrinks to about 35% to 70% of its original size, the separator is regarded as having turned into a closed-pore structure. In this state, the separator may have a pore size of about 0.15 nm to 200 nm, and 50% to 100% of the pores on the separator are at a closed-pore structure, and thus ion transportation in the battery can be stopped.

The hyper-branched polymer of the invention has a “degree of branching (DB)” of more than 0.5. The degree of branching (DB) is defined as follows:

DB=(ΣD+ΣT)/(ΣD+ΣL+ΣT)

, wherein DB represents degree of branching, D represents the number of dendritic units (comprising at least three linkage bonds and no reactive functional group), L represents the number of linear units (two terminals of the unit may be extendable connecting bond), and T represents the number of terminal units (comprising at least one terminal connecting bond and at least one reactive functional group).

The porous hyper-branched polymer may be formed by a reaction of a nitrogen-containing polymer and a diketones-containing compound, wherein (A) the nitrogen-containing polymer includes (A1)) amine, (A2) amide, (A3) imide, (A4) maleimide, (A5) imine, or combinations thereof, and wherein the diketones-containing compound includes barbituric acid (BTA). It should be noted that the nitrogen-containing polymer may include not only nitrogen-containing compounds with number average molecular weights of above 1500 but also nitrogen-containing oligomer with number average molecular weights of between 200 and 1500.

(A1) The amine can be represented by the following general formula:

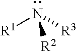

, wherein R¹, R², and R³ may be the same or different, and each represents hydrogen, an aliphatic group, or an aromatic group. A primary amine (where R² and R³ are both hydrogen) is particularly preferred. Illustrative examples of amine (A1) include 1,1′-bis(methoxycarbonyl)divinylamine (BDA), N-methyl-N,N-divinylamine, and divinylphenylamine.

(A2) The amide can be represented by the following general formula:

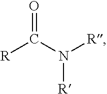

, wherein R, R′, and R″ may be the same or different, and each represents hydrogen, an aliphatic group, or an aromatic group. A primary amide (where R′ and R″ are both hydrogen) is particularly preferred. Illustrative examples of amide (A2) include N-vinylamide, divinylamide, silyl(vinyl)amides, and glyoxylated-vinyl amide.

(A3) The imide can be represented by the following general formula:

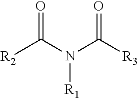

, wherein R¹, R², and R³ may be the same or different, and each represents hydrogen, an aliphatic group, or an aromatic group. Illustrative examples of imide (A3) include divinylimides such as N-vinylimide, N-vinylphthalimide, and vinylacetamide.

(A4) The maleimide includes monomaleimide, bismaleimide, trismaleimide, and polymaleimide, wherein the bismaleimide has the general Formula (I) or (II):

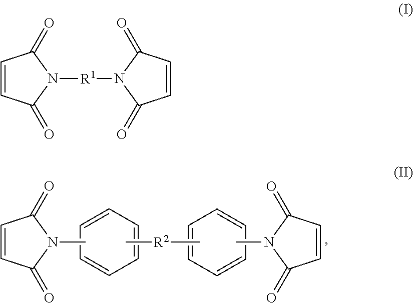

, wherein R¹ is —RCH₂R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —C₆H₅—, —CH₂(C₆H₅)CH₂—, —CH₂(C₆H₅)(O)—, phenylene, diphenylene, substituted phenylene, or substituted diphenylene, and R² is —RCH₂—, —C(O)—, —C(CH₃)₂—, —O—, —O—O—, —S—, —S—S—, —(O)S(O)—, or —S(O)—, and R is C₁₋₆ alkyl. Representative examples of the bismaleimide include N,N′-bismaleimide-4,4′-diphenylmethane, 1,1′-(methylenedi-4,1-phenylene)bismaleimide, N,N′-(1,1′-biphenyl-4,4′-diyl)bismaleimide, N,N′-(4-methyl-1,3-phenylene)bismaleimide, 1,1′-(3,3′-dimethyl-1,1′-biphenyl-4,4′-diyl)bismaleimide, N,N′-ethylenedimaleimide, N,N′-(1,2-phenylene)dimaleimide, N,N′-(1,3-phenylene)dimaleimide, N,N′-thiodimaleimide, N,N′-dithiodimaleimide, N,N′-ketonedimaleimide, N,N′-methylene-bis-maleinimide, bis-maleinimidomethyl-ether, 2-bis-(maleimido)-1,2-ethandiol, N,N′-4,4′-diphenylether-bis-maleimide, 4,4′-bis(maleimido)-diphenylsulfone, and the like.

(A5) The imine can be represented by the following general formula:

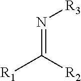

, wherein R¹, R², and R³ may be the same or different, and each represents hydrogen, an aliphatic group, or an aromatic group. Illustrative examples of imine (A5) include divinylimine, and allylic imine.

(B) The dione includes (B1) barbituric acid and derivatives thereof; and (B2) acetylacetone and derivatives thereof.

(B1) The barbituric acid and derivatives thereof can be represented by the following general formula:

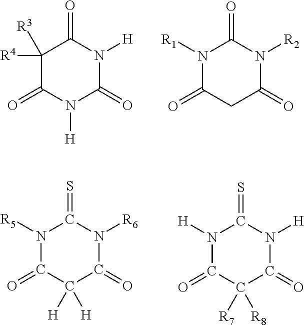

wherein R¹ through R⁸, each independently, represents H, CH₃, C₂H₅, C₆H₅,

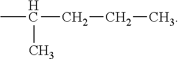

CH(CH₃)₂, CH₂CH(CH₃)₂, CH₂CH₂CH(CH₃)₂, or t,27
The dione is barbituric acid when R′ and R² are both hydrogen.

(B2) The acetylacetone and derivatives thereof can be represented by the following general formula:

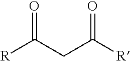

, wherein R and R′ may be the same or different, and each represents an aliphatic group, an aromatic group, or a heteroaryl group. The dione is acetylacetone when R and R′ are both methyl.

The molar ratio of (B) the dione to (A) the amine, amide, imide, maleimide or imine is in the range of about 1:20-4:1, preferably about 1:5-2:1, and more preferably about 1:3-1:1.

In one embodiment, a hyper-branched polymer containing the bismaleimide oligomer is provided. The bismaleimide oligomer is a multi-function bismaleimide oligomer with a hyper branch architecture or multi double-bond reactive functional groups. In the hyper branch architecture, the bismaleimide serves as an architecture matrix. The barbituric acid, as a radical, is grafted to the double bonds of the bismaleimide, such that the double bonds of the bismaleimide may be broken on one or both sides and undergoes a branching and ordering polymerization reaction. In addition, by adjustment of, for example, the concentration ratio, proceeding orders of each steps, reaction temperature, reaction time, or environmental condition, degree of branching, degree of polymerization, structural configuration, and molecular weight can be changed, such that the multi-function bismaleimide oligomer is formed in a high purity. The branch architecture is [(bismaleimide monomer)-(barbituric acid)ₓ]ₘ, wherein x is 0-4 and m (repeating unit) is less than 20.

The hyper-branched polymer described above can be prepared by polymerizing a bismaleimide-containing compound with a barbituric acid or its derivatives in a solvent system. In particular, the molar ratio of the bismaleimide-containing compound and barbituric acid can be 20:1 to 1:5, preferably 5:1 to 1:2.

The solvent used in the invention can be γ-butyrolactone (GBL), 1-methyl-2-pyrrolidinone (NMP), dimethylacetamide (DMAC), N,N-dimethylformamide (DMF), dimethyl sulfoxide (DMSO), dimethylamine (DMA), tetrahydrofuran (THF), methyl ethyl ketone (MEK), propylene carbonate (PC), water, isopropyl alcohol (IPA), or combinations thereof.

The initiator may be an agent, such as peroxide initiators or azo initiators, which generates, upon activation, free radical species through decomposition, and can be 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexanecarbonitrile), 2-(t-butylazo)-2-cyanopropane, 2,2′-azobis[2-methyl-(N)-(1,1)-bis(hydroxymethyl)-2-hydroxyethyl]propionamide, 2,2′-azobis[2-methyl-N-hydroxyethyl)]propionamide, 2,2′-azobis(N,N′-dimethyleneisobutyramidine)dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamid-e, 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), dilauroyl peroxide, tertiary amyl peroxides, tertiary amyl peroxydicarbonates, t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, potassium peroxydisulfate, ammonium peroxydisulfate, di-tert butyl peroxide, di-t-butyl hyponitrite, dicumyl hyponitrite or combinations thereof. Reference may be made to related patent applications of the Applicant such as Taiwan Patent Publication No. 201024343, United States Patent Application No. 20100167101, United States Patent Application No. 20100143767, or Taiwan Patent Publication No. 201025697, for detailed preparation and features of the hyper-branched polymer.

The hyper-branched polymer will change its free volume at a field effect condition, such as a current, voltage, temperature, or light. For example, at a temperature of 70° C., the hyper-branched polymer has the largest free volume, and thus ions (such as lithium ions) in the electrolyte can pass through the polymer freely, and therefore the hyper-branched polymer can function as a battery separator. However, when the temperature in the battery increases, the free radius of the hyper-branched polymer may decrease gradually. In other words, the pore size of the hyper-branched polymer will become smaller. Therefore, the ion transportation rate in the electrolyte will slow down, and rapid increase of the battery temperature can be avoided. When the temperature in the battery is above 150° C., the hyper-branched polymer will gradually react with each other to from a cross-linkage structure, thereby further reducing its free volume. When the temperature in the battery is above 200° C., the free volume of the hyper-branched polymer is so small that solvated lithium ions in the electrolyte can not pass through the separator. Therefore, the separator can be regarded as being a closed-pore structure, such that ion transportation in the battery is slowed down or stopped, and the temperature in the battery can stop increasing. Furthermore, the hyper-branched polymer has excellent insulating ability, heat resistance, chemical stability, and electrolyte retention ability. Thus, electrical property and safety of the battery are improved.

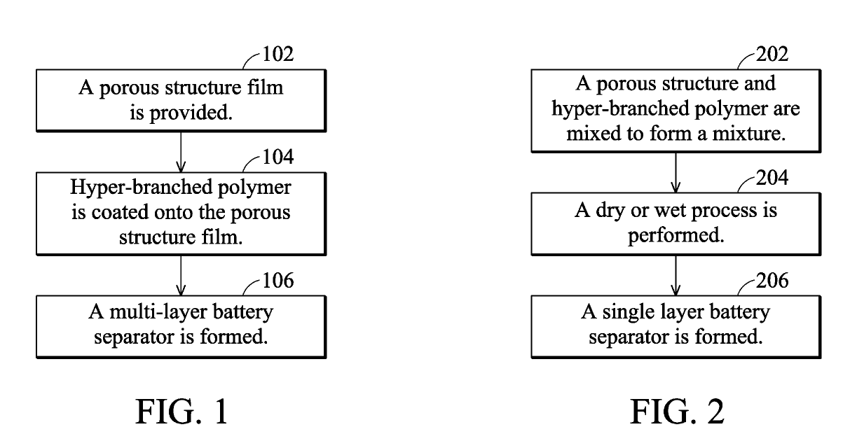

FIG. 1 is a flow chart of a method for manufacturing a battery separator according to one embodiment of the invention. A porous structure film is provided in step 102. A hyper-branched polymer is coated onto the porous structure film (in step 104) to form a battery separator (in step 106.)

In step 102, the porous structure film is provided by a dry process or a wet process. The dry process includes, for example, melting the porous structure material and extruding the material into a film. Next, an annealing process is performed and the film is stretched at a relatively low temperature to generate pores. Then, the film is stretched again at a relatively high temperature to form a micro-porous structure film. On the other hand, the wet process includes, for example, mixing and melting the porous structure material with a diluent at a high temperature to form a mixture. Next, the mixture is processed into a sheet and then stretched to form a film. Then, the diluent is extracted out of the film by using a volatile solvent (such as trichloroethylene). The space, previously occupied by the diluent thus becomes the pores in the porous structure film. The diluent may include γ-butyrolactone (GBL), 1-methyl-2-pyrrolidinone (NMP), dimethylacetamide (DMAC), N,N-dimethylformaide (DMF), dimethylsulfoxide (DMSO), dimethylamine (DMA), tetrahydrofuran (THF), methyl ethyl ketone (MEK), propylene carbonate (PC), isopropylacohol (IPA), or combinations thereof.

The porous structure material may include polyethylene (PE), polypropylenem (PP), polytetrafluoroethylene (PTFE), polyamide, polyvinyl chloride (PVC), polyvinylidene chloride (PVDC), polyaniline, polyimide (PI), nonwoven fabric, polyethylene terephthalate, polystyrene (PS), cellulose, or combinations thereof.

In one embodiment, before step 104, a surface modification is performed. The surface modification is performed by alkalizing the surface of the porous structure film. A dehydration and grafting reaction of maleimidobenzoic acid is performed in N-methyl-2-pyrrolidone (NMP) at a temperature of 40° C. to 80° C. The maleimidobenzoic acid can be grafted onto the surface of the porous structure material, by selection of appropriate materials and structural design and utilizing multi-level grafting techniques. Then, the monomer set is added into NMP, and the reaction continues at a temperature of 40° C. to 80° C. in NMP, such that the hyper-branched polymers are formed in situ on the surface of the porous structure material. In addition, the surface modification can also be performed by a plasma process. The surface of the porous structure material is charged by plasma to induce a polymerization reaction of the monomer set in situ thereon.

In step 104, the hyper-branched polymer is coated onto the porous structure film to form the battery separator described in step 106. The hyper-branched polymer may be coated by spin coating, casting, bar coating, blade coating, roller coating, wire bar coating, dip coating, or the like.

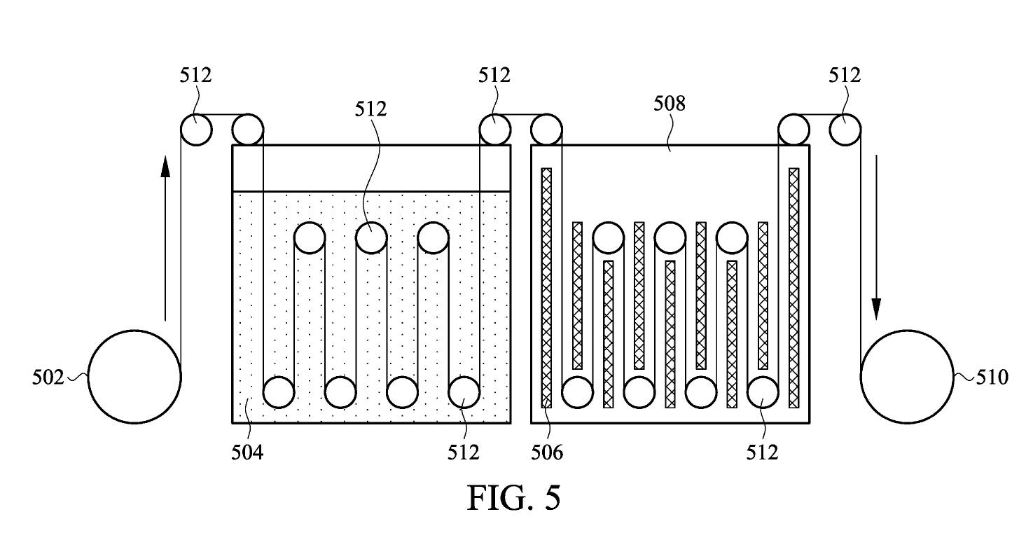

In one embodiment, the hyper-branched polymer is coated onto the porous structure film by a dip coating process. Referring to FIG. 5, an untreated porous structure film is placed into the hyper-branched polymer solution 504 by a roller 512 of a separator dispensing reel 502. The temperature of the hyper-branched polymer solution can be adjusted (from room temperature to 100° C.) when proceeding with the coating. Then, the separator is dried in an oven 508 with an infrared heating plate 506 therein. The multi-layer separator thus formed is collected by a separator retrieving reel 510.

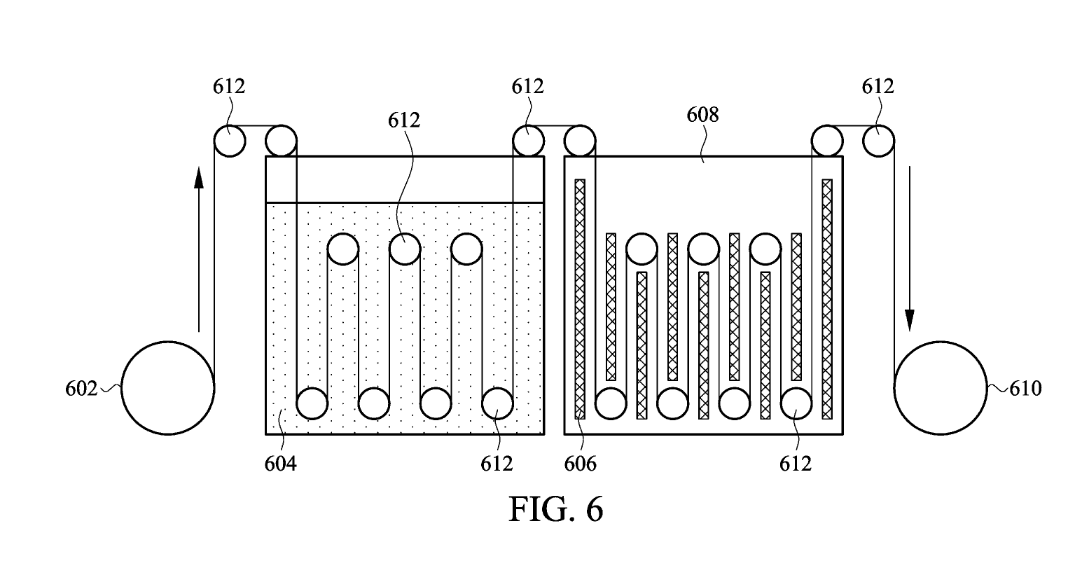

In another embodiment, the hyper-branched polymer is coated onto the porous structure film by an in situ coating process. Referring to FIG. 6, an untreated porous structure film is placed into the hyper-branched polymer monomer set solution 604 by a roller 612 of a separator dispensing reel 602. The temperature of the hyper-branched polymer monomer set solution can be adjusted (from room temperature to 100° C.) when proceeding with the coating. Then, the separator is dried in an oven 608 with an infrared heating plate 606 therein. The multi-layer separator is obtained by a separator retrieving reel 610.

In one embodiment, a surface modification process is performed before the hyper-branched polymer is coated onto the porous structure film. The surface modification was performed by alkalizing the surface of the hyper-branched polymer. A dehydration and grafting reaction of maleimidobenzoic acid is performed in N-methyl-2-pyrrolidone (NMP) at a temperature of 40° C. to 80° C. The maleimidobenzoic acid can be grafted onto the surface of the hyper-branched polymer, by selection of appropriate materials and structural design and utilizing multi-level grafting techniques. Then, the porous structure film with alkalized surface is immersed into the modified hyper-branched polymer solution. The hyper-branched polymer is coated onto the surface of the alkalized porous structure material in situ in NMP at a temperature of 40° C. to 80° C. In addition, the surface modification process can be performed by a plasma process. The surface of the porous structure material is charged by plasma, such that modified hyper-branched polymer is coated onto the surface of the porous structure material in situ.

In another embodiment, the hyper-branched polymer is pre-mixed with a binder before it is coated onto the porous structure film. The binder may include polyvinylidene chloride, styrene-butadiene rubber (SBR), polyamide, melamine resin, or combinations thereof.

In step 106, the battery separator is provided. The battery separator includes the porous structure film and the hyper-branched polymer, wherein the hyper-branched polymer undergoes a closed-pore mechanism at a field effect condition. The hyper-branched polymer on the porous structure film may have a pore size of between 0.2 nm and 500 nm, preferably of between 0.3 nm and 300 nm. The hyper-branched polymer may have a thickness of below 5 μm.

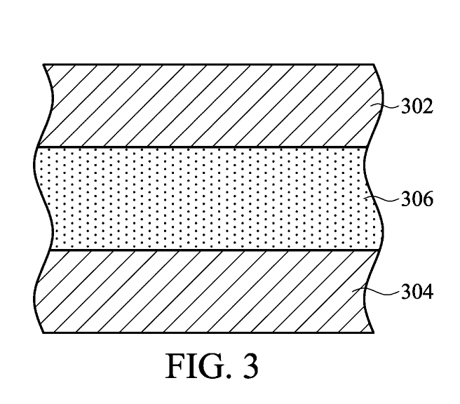

FIG. 2 illustrates a flow chart of a method for manufacturing a battery separator according to another embodiment of the invention. In step 202, the porous structure material and the hyper-branched polymer are mixed to form a mixture. In step 204, a dry or wet process is performed to form a battery separator in step 206. In the embodiment, the battery separator is a single film.

In step 202, the porous structure material and the hyper-branched polymer are mixed to form a mixture. The porous structure material may include polyethylene, polypropylene, poly(tetrafluoroethylene), polyamide, poly(viny chloride), polyvinylidine fluride, polyaniline, polyimide, nonwoven, polyethylene terephthalate, polystyrene, or combinations thereof. The porous hyper-branched polymer is formed by a reaction of a nitrogen-containing polymer and a diketones-containing compound, wherein the nitrogen-containing polymer includes amine, amide, imide, maleimides, imine, or combinations thereof, and wherein the diketones-containing compound includes barbituric acid (BTA). In one embodiment, the hyper-branched polymer monomer set solution is added into the porous structure material solution. The mixture is then placed in a reaction tank. The temperature of the mixed solution can be adjusted (from room temperature to 150° C.) to perform an in situ blending reaction, such that the porous structure material and the hyper-branched polymer are evenly blended to construct a semi-interpenetrating polymer network (semi-IPN) structure in the solvent system.

In another embodiment, the mixture further includes a binder. The binder may include polyvinylidene chloride, styrene-butadiene rubber (SBR), polyamide, melamine resin, or combinations thereof. In another embodiment, the porous structure material is modified before being mixed with the hyper-branched polymer. The modification is performed by alkalizing the surface of the porous structure material. A dehydration and grafting reaction of maleimidobenzoic acid is performed in N-methyl-2-pyrrolidone (NMP) at a temperature of 40° C. to 80° C. The maleimidobenzoic acid can be grafted onto the surface of the porous structure material, by selection of appropriate materials and structural design and utilizing multi-level grafting techniques. Then, the monomer set is added into the NMP, and the reaction continues at a temperature of 40° C. to 80° C. in NMP. The hyper-branched polymer is formed in situ on the surface of the porous structure material. In addition, the surface modification can be performed by a plasma process. The surface of the porous structure material is charged by plasma to induce the monomer set to undergo a polymerization reaction in situ thereon. In still another embodiment, the hyper-branched polymer is modified before being mixed with the porous structure material. The modification is performed by alkalizing the surface of the hyper-branched polymer. A dehydration and grafting reaction of maleimidobenzoic acid is performed in N-methyl-2-pyrrolidone (NMP) at a temperature of 40° C. to 80° C. The maleimidobenzoic acid can be grafted onto the surface of the hyper-branched polymer, by selection of appropriate materials and structural design and utilizing multi-level grafting techniques. Then, the porous structure film having alkalized surface is immersed into the modified hyper-branched polymer solution. The hyper-branched polymer is coated onto the surface of the alkalized porous structure material in situ in NMP at a temperature of 40° C. to 80° C. In addition, the surface modification can be performed by a plasma process. The surface of the porous structure material is charged by plasma. The modified hyper-branched polymer is coated onto the surface of the porous structure material in situ.

In step 204, a dry or a wet process is performed to the mixture to form the battery separator in step 206.

The dry process includes, for example, melting the mixture and extruding the material into a film. Next, an annealing process performed and the film is stretched at a relatively low temperature to generate pores. Then, the film is stretched again at a relatively high temperature to form a micro-porous structure film. On the other hand, the wet process includes, for example, mixing and melting the mixture with a diluent at a high temperature to form a single sheet. Then, the diluent is extracted out of the film by using a volatile solvent (such as trichloroethylene). The space previously occupied by the diluent thus becomes the pores in the film. In one embodiment, the separator is made into a fiber form by spinning or electrostatic spinning.

In step 206, the separator is formed. The separator includes a single film made of the porous structure material and the hyper-branched polymer, wherein the hyper-branched polymer undergoes a closed-pore mechanism at a field effect condition. A pore size of the hyper-branched polymer may be between 0.2 nm and 500 nm, preferably between 0.3 nm and 300 nm. A thickness of the film may be less than about 5 μm.

FIG. 3 illustrates a cross-section of a lithium battery according to one embodiment of the invention. The battery includes an anode plate 302 and a cathode plate 304. A separator 306 is disposed between the anode plate 302 and the cathode plate 304. The separator 306 includes electrolyte. In addition, a package may be provided to encapsulate the anode plate 302, the cathode plate 304, the separator 306, and the electrolyte inside the separator (not shown). In one embodiment, the separator is a single film made of the porous structure material and the hyper-branched polymer. In another embodiment, the separator is a multi-layer film including the porous structure film and hyper-branched polymer.

Referring to FIG. 3, in a secondary battery, the separator having the hyper-branched polymer can prevent the battery from over-heating which results in safety concerns. The hyper-branched polymer has good affinity toward the electrode plates. After the assembly process, the hyper-branched polymer contacts with the electrode plates and induce an in situ binding reaction in an electrolyte during charging, discharging, and aging processes. As the separator and the electrode plates are better attached to each other, a transportation resistance of the lithium ion in the battery reduces as a result. Conventionally, a closed-pore layer in a battery separator may be such as polyethylene (PE). When the battery temperature reaches the closed-pore temperature (about 130° C.), the PE layer will melt and seal the pores of the separator. The lithium ion transportation may be stopped. This should stop the continuing reaction in the battery and prevent the battery from over-heating or even explosion. However, before the temperature comes to the closed-pore temperature, ions continuously transport in the electrolyte rapidly. Therefore, even when the pores in the separator shut-down, the temperature in the battery may not be able to stop increasing immediately. In addition, the melted PE layer may not be able to cover all the pores in the separator, and therefore there are still some open pores in the separator that keep the reaction going. The temperature in the battery may therefore keep rising and the separator may be over-melted, resulting in a direct contact of the anode and the cathode. The shorting may cause a chain reaction that leads to severe results such as thermal runaway and exposure.

However, according to one embodiment, the separator of the invention undergoes a closed-pore mechanism at a field effect condition, and can further form a shut-down structure. For example, by adjusting the temperature, the free volume of the hyper-branched polymer reaches the maximum size at a temperature of 70° C. After the temperature in the battery increases, the free volumes of the pores become smaller. That is, when the temperature in the battery reaches about 70° C. or 80° C., the pore size of the separator begins to shrink, and the ion transportation rate starts to reduce. Therefore, before the temperature in the battery reached 200° C. resulting in the shut-down structure of the separator (for example, at a temperature of about 150° C.), the reaction in the battery has already slowed down. Thus, when the separator shuts-down, the temperature in the battery can effectively stop increasing.

Moreover, the pore size of the hyper-branched polymer is smaller than the conventional separator. For the hyper-branched polymer, the free volume shrinks as soon as the temperature starts to rise, and the ion transportation will soon be hindered. Therefore, the ion transportation rate reduces, and so does the reaction rate in the battery. However, conventionally, the pore size of the separator is much larger than the lithium ions. The pores inside the separator have to shrink a great percentage of the original size to a size that is small enough to hinder the ion transportation. Therefore, the ion transportation rate in the battery can not be reduced until the pores in the separator completely become closed. In addition, since the pores in the conventional separator are so large, a great amount of the porous structure film (such as PE) is required. Usually there is not enough PE to seal all of the pores inside the separator, and therefore the pores of the separator can only be partially shut-down.

Furthermore, a conventional polyethylene separator will melt down at the shut-down temperature and lose its function as a battery separator. However, the free volume of the hyper-branched polymer of the invention can be adjusted reversibly before the battery temperature reaches the shut-down temperature. That is, when the temperature reaches about 70° C., the free volume of the hyper-branched polymer in the battery separator reduces, and the reaction rate in the battery is limited. Therefore, the possibility for the battery temperature reaching to the shut-down temperature decreases, and the duration of the battery is prolonged. In addition, by controlling the ion transportation rate in the battery gradually while the temperature is increasing, the current and voltage of the battery can also be stabilized.

Conventionally, research related to battery separators focus on increasing the heat-resistant temperature of the separator. However, when the battery temperature reaches over 200° C., the electrodes start to decompose and react with the electrolyte at the high temperature. Therefore, the risk of battery explosion still exists. Thus, the safety of the battery can not be improved effectively by simply increasing the heat-resistant temperature. On the other hand, the hyper-branched polymer of the invention is a heat-resistant material. When the temperature reaches about 70° C. or 80° C., the ion transportation rate of the battery having the hyper-branched polymer starts to reduce. When the temperature reaches 150° C., the separator undergoes a shut-down mechanism to hinder the solvated lithium ions to be transported in the battery. Therefore, it can reduce the increase of the battery temperature or even prevent the temperature from increasing. As a result, the electrodes of the battery will not be decomposed under high temperature, and a thermal runaway or explosion will not occur because the oxidation-reduction reaction between the electrodes and the electrolyte is avoided.

However, even if the battery temperature keeps increasing, the hyper-branched polymer can be decomposed into fire-retardant chemicals such as CO₂, NO₂, or the like. Therefore, the safety of the battery is improved.

In addition to the reasons described above, another advantage of using the hyper-branched polymer as a battery separator is that it can improve the charging-discharging rate of the battery.

The hyper-branched character of the hyper-branched polymer results in the poor affinity between its molecules, and therefore, the pores in the structure are formed naturally. In comparison, the battery separator made by mechanical stretching in the conventional dry film process has a larger pore size, and requires a larger film thickness to avoid breakage during the manufacturing process.

In one embodiment of the invention, the battery separator may be made thinner, and therefore the ion transportation resistance may be reduced. Therefore, the charging-discharging rate of the battery may be improved.

The conventional battery separator used in a secondary battery may be such as polyethylene (PE), polypropylene (PP), or the like. The used electrolyte may be such as diethyl carbonate (DEC), ethylene carbonate (EC), propylene carbonate (PC), or the like. Since PE and PP have poor wetting toward PC and EC, the lithium ions in the battery can not pass through the separator freely. Therefore, the conventional electrolyte requires more than 50% of the DEC, which has a better wetting toward PE and PP. However, lithium has poor dissociation constant in DEC, and a great amount of lithium salts is required in order to release sufficient lithium ions in the battery. The cost of the process is therefore increased.

However, in one embodiment of the invention, the battery separator having the hyper-branched has a better wetting toward the electrolyte, and therefore the conventional electrolyte composition can be changed. In the secondary battery with the separator having the hyper-branched polymer, the electrolyte may contain less DEC. For example, the DEC of the electrolyte is between 10% and 50%, preferably between 20% and 45%. In one example, the electrolyte composition may be EC: PC: DEC=3:2:5 (v:v:v), EC: PC: DEC=1:1:1(v:v:v), or EC: PC: DEC=2:1:2(v:v:v). Since the hyper-branched polymer has a better wetting toward the electrolyte, the lithium ion transportation rate can be increased, such that the charging and discharging rate is improved. Furthermore, by reducing the amount of the DEC in the electrolyte, more lithium ions can be released into the electrolyte, and the electrical capacity is also improved. In addition, the electrolyte retention ability of the separator can also be improved due to the hyper-branched polymer.

### Example 1

### Manufacture of the hyper-branched polymer

Hyper-Branched Polymer-a

2.55 g (0.0071M) of N-N′-4,4′-diphenylmethylbismaleimide and 0.45 g (0.0036M) of the barbituric acid were placed into a four-necked reactor (250 mL). 97.00 g of NMP was then added into the reactor to dissolve the reactants by stirring. The reaction was continued for 48 hours under nitrogen at a temperature of 130° C., and a nitrogen containing polymer having a solid content of 3.0% was obtained, wherein the DSC (10° C./min@N₂) showed that the thermal onset temperature was between 90° C. and 260° C., and the optimum thermal onset temperature was between 140° C. and 200° C.

Hyper-branched polymer-b

16.97 g (0.0474M) of N-N′-4,4′-diphenylmethylbismaleimide and 3.033 g (0.0237M) of the barbituric acid were placed into a four-necked reactor (250 mL). 80.00 g of γ-butyrolactone (GBL) was then added into the reactor to dissolve the reactants by stirring. The reaction was continued for 6 hours under nitrogen at a temperature of 130° C., and a nitrogen containing polymer having a solid content of 20.0% was obtained, wherein the DSC (10° C./min@N₂) showed that the thermal onset temperature was between 100° C. and 240° C., the optimum thermal onset temperature was between 120° C. and 180° C.

Hyper-Branched Polymer-C

6.36 g (0.0178M) of N-N′-4,4′-diphenylmethylbismaleimide and 1.14 g (0.0089M) of the barbituric acid were placed into a four-necked reactor (250 mL). 92.50 g of a mixture of NMP and N′N′-dimethyl acetamide (DMAC) (1:1; weight) was then added into the reactor to dissolve the reactants by stirring. The reaction was continued for 12 hours under nitrogen at a temperature of 130° C., and a nitrogen containing polymer having a_solid content of 7.5% was obtained, wherein the DSC (10° C./min@N₂) showed that the thermal onset temperature was between 90° C. and 260° C., and the optimum thermal onset temperature was between 140° C. and 100° C.

Hyper-Branched Polymer-d

2.55 g (0.0071M) of N-N′-4,4′-diphenylmethylbismaleimide and 0.45 g (0.0039M) of the acetylactone were placed into a four-necked reactor (250 mL). 97.00 g of N,N-dimethylformamide (DMF) was then added into the reactor to dissolve the reactants by stirring. The reaction was continued for 48 hours under nitrogen at a temperature of 130° C., and a nitrogen containing polymer having a solid content of 3.0% was obtained, wherein the DSC (10° C./min@N₂) showed that the thermal onset temperature was between 150° C. and 250° C., the optimum thermal onset temperature was between 170° C. and 210° C.

Hyper-Branched Polymer-e

2.55 g (0.0071M) of polymaleimide and 0.45 g (0.0029M) of the 1,3-dimethylbarbituric acid were placed into a four-necked reactor (250 mL). 97.00 g of a co-sol vent of propylene carbonate and diethyl carbonate (DEC) (4:6; vol) was then added into the reactor to dissolve the reactants by stirring. The reaction was continued for 48 hours under nitrogen at a temperature of 130° C., and a nitrogen containing polymer having a solid content of 3.0% was obtained, wherein the DSC (10° C./min@N₂) showed that the thermal onset temperature was between 170° C. and 280° C., and the optimum thermal onset temperature was between 190° C. and 240° C.

Hyper-Branched Polymer-f

1.23 g (0.0026M) of polymaleimide and 3.033 g (0.0237M) of the barbituric acid were placed into a four-necked reactor (250 mL). The reaction was continued for 30 minutes under nitrogen at a temperature of 130° C., and a nitrogen containing polymer was obtained, wherein the DSC (10° C./min@N₂) showed that the thermal onset temperature was between 180° C. and 250° C., the optimum thermal onset temperature was between 190° C. and 230° C.

Hyper-Branched Polymer-g

2.8 g (0.0060M) of polymaleimide and 0.20 g (0.0016M) of the barbituric acid were placed into mechanical stirring reactor. The stirring process (500 rmp) continued for 30 minutes at solid state under nitrogen at a temperature of 130° C., and a nitrogen containing polymer was obtained, wherein the DSC (10° C./min@N₂) showed that the thermal onset temperature was between 130° C. and 240° C., the optimum thermal onset temperature was between 160° C. and 220° C.

Hyper-branched polymer-h

2.55 g (0.0071M) of N-N′-4,4′-diphenylmethylbismaleimide, 1.54 g (0.0071M) of the 1,4-maleimidobenzoic acid, and 0.91 g (0.0071M) of barbituric acid were placed into a four-necked reactor (250 mL). 95.00 g of NMP was then added into the reactor to dissolve the reactants by stirring. The reaction was continued for 24 hours under nitrogen at a temperature of 130° C., and a nitrogen containing polymer having a solid content of 5.0% was obtained, wherein the DSC (10° C./min@N₂) showed that the thermal onset temperature was between 90° C. and 220° C., and the optimum thermal onset temperature was between 130° C. and 180° C.

Hyper-branched polymer-i

0.85 g (0.0024M) of N-N′-4,4′-diphenylmethylbismaleimide and 0.15 g (0.0012M) of barbituric acid were placed into a four-necked reactor (250 mL). 9 g of NMP was added into the reactor and heated to 60° C. Then, the mixture was stirred until all of the compound was dissolved. 100 g of the polyacrylnitrile(PAN)/N,N-dimethylacetamide (DMAC) solution (solid content of 10.0 wt %) was added into the mixture. The reaction was continued for 24 hours under nitrogen at a temperature of 130° C. and a (PAN-STOBA)-DMAC/NMP solution having a solid content of 10.0% was obtained. By electrostatic spinning, film in a fiber form was made, and a non-woven separator was further provided after pressing (7N). The DSC (10° C./min@N₂) showed that the thermal onset temperature was between 180° C. and 300° C., the optimum thermal onset temperature was between 240° C. and 280° C.

### Comparative Example 1

Polyethylene terephthalate (PET) was dissolved in N,N′-dimethylacetamide (DMAC) to form a solution having a solid content of 10 wt %. Charge was induced in the PET solution through contact with a 40 KV voltage electrode in a spinnerette, resulting in ejection of a single jet of charged PET solution. The charged jet was accelerated and thined in the electric field. In this process, the solvent evaporated rapidly and a non-woven mat containing nano-scale fibers was formed. Finally, a heat pressing process (200 kg) and rolling pressing process (20 kg) were performed to form a PET non-woven separator as a battery separator. A thickness of the separator was of between 10 μm and 50 μm. Pore size of the separator was between 0.5 μm and 2 μm.

### Comparative Example 2

Polypropylene porous structure material was dissolved in N,N′-dimethylacetamide (DMAC) to form a solution having a solid content of 10 wt %. Charge was induced in the polypropylene solution through contact with a 40 KV voltage electrode in a spinnerette, resulting in ejection of a single jet of charged polypropylene solution. The charged jet was accelerated and thined in the electric field. In this process, the solvent evaporated rapidly and a non-woven mat containing nano-scale fibers was formed. Finally, a heat pressing process (200 kg) and rolling pressing process (20 kg) were performed to form a polypropylene non-woven separator as a battery separator. The thickness of the separator was of between 10 μm and 50 μm. The pore size of the separator was between 0.5 μm and 2 μm.

### Comparative Example 3

Polyaniline porous structure material was dissolved in N,N′-dimethylacetamide (DMAC) to form a solution having a solid content of 10 wt %. Charge was induced in the polyaniline solution through contact with a 40 KV voltage electrode in a spinnerette, resulting in ejection of a single jet of charged polyaniline solution. The charged jet was accelerated and thined in the electric field. In this process, the solvent evaporated rapidly and a non-woven mat containing nano-scale fibers was formed. Finally, a heat pressing process (200 kg) and rolling pressing process (20 kg) were performed to form a polyaniline non-woven separator as a battery separator. The thickness of the separator was of between 10 μm and 50 μm. The pore size of the separator was between 0.5 μm and 2 μm.

### Comparative Example 4

Polyethylene porous structure material was dissolved in N,N′-dimethylacetamide (DMAC) to form a solution having a solid content of 10 wt %. Charge was induced in the polyethylene solution through contact with a 40 KV voltage electrode in a spinnerette, resulting in ejection of a single jet of charged polyethylene solution. The charged jet was accelerated and thined in the electric field. In this process, the solvent evaporated rapidly and a non-woven mat containing nano-scale fibers was formed. Finally, a heat pressing process (200 kg) and rolling pressing process (20 kg) were performed to form a polyethylene non-woven separator as a battery separator. The thickness of the separator was of between 10 μm and 50 μm. The pore size of the separator was between 0.5 μm and 2 μm.

### Example 2

A PET porous structure material film was formed and subjected to a pressing process. Then, the PET film was placed into a solution containing the hyper-branched polymer. The temperature of the solution was adjusted (from room temperature to 100° C.), and the reaction was continued for 10 minutes to 6 hours. After that, the separator was taken out of the solution and cleaned by acetone or acetone/methanol (1:1; vol). The separator was then dried by an IR heater at a temperature of 40° C. to 80° C. A porous structure non-woven separator having the hyper-branched polymer was formed. A thickness of the separator was between about 10 μm and 50 μm. The pore size of the separator was between 0.5 μm and 2 μm.

Since the molecules of the hyper-branched polymer had poor affinity between each other, pores were naturally formed in the structure. The pore size was relatively small compared to pore size of conventional separators, and the thickness was also thinner. Therefore, the resistant of ion transportation in the electrolyte was reduced, and the charging and discharging rate was improved.

### Example 3

A polypropylene porous structure material film was formed and subjected to a pressing process. Then, the PET film was placed into a solution containing the hyper-branched polymer. The temperature of the solution was adjusted (from room temperature to 100° C.), and the reaction was continued for 10 minutes to 6 hours. After that, the separator was taken out of the solution and cleaned by acetone or acetone/methanol (1:1; vol). The separator was then dried by an IR heater at a temperature of 40° C. to 80° C. A porous structure non-woven separator having the hyper-branched polymer was formed. A thickness of the separator was between about 10 μm and 50 μm. The pore size of the separator was between 0.5 μm and 2 μm.

### Example 4

The hyper-branched polymer monomer set was added into a porous structure material solution containing polyaniline and cellulose. The mixture was placed into a reactor and a temperature of the solution was adjusted (from room temperature to 150° C.). The mixture underwent an in situ blending reaction to evenly blend the porous structure material and the hyper-branched polymer to form a semi-IPN structure in the solvent. By electrostatic spinning, an improved separator in a fiber form was provided. Pore size of the separator was between about 0.2 nm to 500 nm, and the optimum pore size was between 0.3 nm and 300 nm. Porosity of the separator was between 10% and 80%, and the optimum porosity was between 30% and 60%.

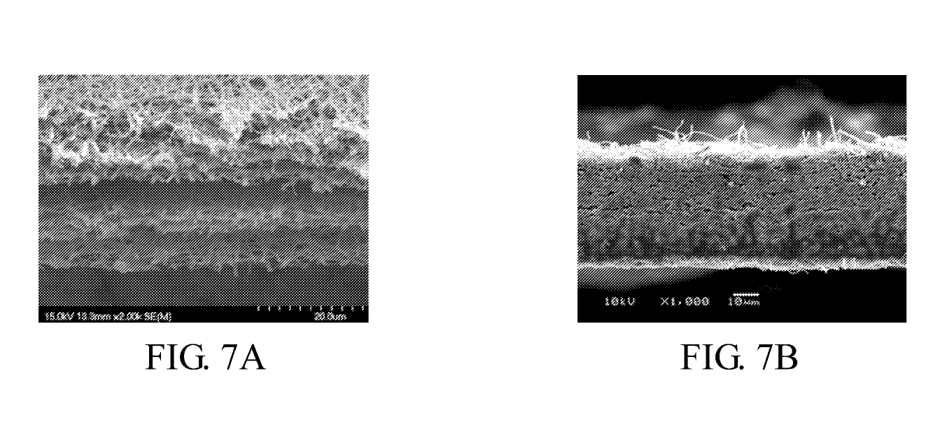

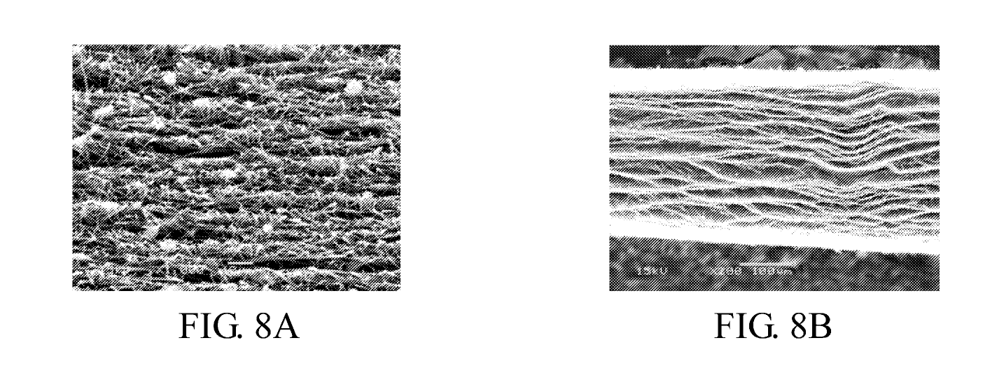

The thickness of the film of comparative example 3 changed greatly before and after the pressing process. As shown in FIG. 7, after the heat pressing process and the rolling pressing process, the PAN structure became tightly connected and was unfavorable for solvated lithium ion transportation. On the other hand, regarding the PAN structure modified by the hyper-branched polymer as shown in FIG. 8, distance between the molecular structures was fixed due to the repellence between the hyper-branched polymers. Therefore, the thickness of the separator before and after the pressing process was not so different when compared to the conventional separator. After the pressing process, the pore size became smaller and the porosity increased. In addition, the size and distribution of the pores in the separator were more uniform than pores of conventional separators.

Moreover, compared to the separators in the comparative examples, the separator of this example had a smaller pore size. Therefore, when the battery temperature started to rise, the free volume of the separator started to shrink and the ion flux in the battery started to reduce. The battery temperature was stopped from increasing, and the safety of the battery was improved.

### Example 5

The porous structure film formed of polypropylene was placed into the hyper-branched polymer monomer set solution. The reaction temperature of the solution was adjusted (from room temperature to 150° C.). A surface modification was performed on the surface of the film in situ to improve the performance of the separator. A thickness of the film was between about 10 μm and 50 μm, and pore size was between about 0.5 μm and 2 μm.

The result of comparative examples 1-4 and examples 1-4 are shown in Table 1. The average thickness was measured according to ASTM D5947-96. The tensile strength was measured according to ASTM D882. The gurley value was measured according to ASTM D726. The maximum pore size and the mean pore size were measured according to ASTM E128-99. The heat shrinkage was measured according to ASTM D1204. The temperature stability was measured according to ASTM D1204.

Referring to Table 1, the battery separator having the hyper-branched polymer had better tensile strength, heat shrinkage, or/and temperature stability. In Example 4, the battery separator having the hyper-branched polymer had thinner fiber and the porosity of the separator highly increased after heat pressing. In addition, the gurley value and wettability of the separator toward the solvents were also better than the conventional ones.

TABLE 1

| | | | Comparative examples and examples | | | | | | | |
|---|---|---|---|---|---|---|---|---|---|---|
| | | | Compara- | Compara- | Compara- | Compara- | | | | |
| | | | tive | tive | tive | tive | | | | |
| | | | example 1 | example 2 | example 3 | example 4 | Example 2 | Example 3 | Example 4 | Example 5 |
| Composition | | | PET/ | PP/ | PAN/ | PE | PP/cellulose- | PP/cellulose - | PAN-hyper- | PE-hyper- |
| | | | cellulose | cellulose | cellulose | | hyper- | hyper- | branched | branched |
| | | | | | | | branched | branched | polymer/ | polymer |
| | | | | | | | polymer | polymer | cellulose | |
| Major component | | | PET/ | PP/ | PAN/ | PE | PET/ | PP/ | PAN/ | PE |
| | | | cellulose | cellulose | cellulose | | cellulose | cellulose | cellulose | |
| Type of the hyper-branched polymer | | | | | | | hyper- | hyper- | hyper- | hyper- |
| | | | | | | | branched | branched | branched | branched |
| | | | | | | | polymer -a | polymer -b | polymer -i | polymer -e |
| Sinking or mixing temperature | | | | | | | 25° C. | 80° C. | 130° C. | 50° C. |
| Color of the separator | | | White | White | While | White | Brown | Light brown | Brown | Light brown |
| Properties | Orientation | Unit | | | | | | | | |
| Average weight | | g/m² | 16.0 | 16.1 | 26.8 | 10.5 | 16.9 | 16.7 | 20.4 | 10.8 |
| Mean thickness | | μm | 30 | 25 | 27 | 25 | 30 | 25 | 27 | 25 |
| Tensile | MD | Kg/cm² | 650 | 1150 | 500 | 1350 | 685 | 1210 | 522 | 1375 |
| strength | TD | Kg/cm³ | 440 | 112 | 450 | 1100 | 460 | 120 | 426 | 1150 |
| Porosity | | % | 55 | 40 | 35 | 41 | 54 | 40 | 45 | 41 |
| Gurley value | | Sec | 8 | 25 | 44 | 22 | 8 | 25 | 16 | 22 |
| Wettability | | | poor | poor | good | poor | good | good | excellent | good |
| toward PE \grave{ } EC | | | | | | | | | | |
| \grave{ } GBL | | | | | | | | | | |
| Max pore size | | μm | 2.0 | 4.4 | 0.9 | 0.04*0.9(two | 1.8 | 4.1 | 1.2 | 0.04*0.9(two |
| Mean pore size | | Mm | 0.7 | 2.1 | 0.3 | axis of a | 0.6 | 1.9 | 0.5 | axis of a |
| | | | | | | elongated | | | | elongated |
| | | | | | | pore) | | | | pore) |
| Heat shrinkage | MD | % | 1.3 | 3.4 | 1.5 | 24.7 | 1.2 | 2.9 | 1.6 | 21.3 |
| at 90° C./1 hr | TD | % | 1.1 | 1.5 | 1.0 | 4.2 | 1.1 | 1.4 | 1.1 | 3.7 |
| Melt-down | | ° C. | 253 | 160 | 270 | 132 | 261 | 166 | 275 | 143 |
| temperature | | | | | | | | | | |
| Shut-down | | ° C. | 235 | 140 | 245 | 120 | 245 | 145 | 250 | 135 |
| temperature | | | | | | | | | | |
| Temperature | | ° C. | 215 | 120 | 225 | 100 | 225 | 125 | 230 | 115 |
| stability | | | | | | | | | | |

### Example 6

Porous structure separators were made of non-woven/PET (surface modifying), non-woven/PET (Mitsubishi Paper), or non-woven/PP (15 mg/cm²) respectively. Each of the porous structure film was pressed and placed into the hyper-branched polymer solution. The solution temperature was adjusted (from room temperature to 100° C.). A surface modification was performed to improve the performance of the separator. The surface modification was performed by alkalizing the surface of the porous structure film. A dehydration and grafting reaction of maleimidobenzoic acid was performed in N-methyl-2-pyrrolidone (NMP) at a temperature of 40° C. to 80° C. The maleimidobenzoic acid was grafted onto the surface of the porous structure material by selection of appropriate materials and structural design and utilizing multi-level grafting techniques. Then, the monomer set was added into NMP, and the reaction was continued at a temperature of 40° C. to 80° C. in NMP, such that the hyper-branched polymers was formed in situ on the surface of the porous structure material. In addition, the surface modification was also performed by a plasma process. The surface of the porous structure material was charged by plasma to induce a polymerization reaction of the monomer set in situ thereon.

The hyper-branched polymer had the best coating ability toward the PET (with surface modification). The coating ability of the hyper-branched polymer toward the non-woven/PET (Mitsubishi Paper) was worse than that toward the PET (with surface modification), but better than that toward the non-woven/PP (15 mg/cm²).

In addition, the fiber of the separator having polyaniline-hyper-branched polymer was thinner than the fiber of the separator having only polyaniline. Also, its porosity and the uniformity were also better than the separator having only polyaniline. The surface modified separator was analyzed by SEM-EDX and nitrogen-containing signals were detected. The result indicated that a nitrogen-containing polymer was coated onto the surface of the non-woven separator.

### Example 7

The separators formed in comparative examples and examples were tested for the wettability toward different kinds of solvents, including γ-butyrolactone (GBL), 1-methyl-2-pyrrolidinone (NMP), propylene carbonate (PC), dimethylene carbonate (DMC), diethylene carbonate (DEC), EC/PC/DEC (3:2:5, in volume), and EC/PC/DEC (2:1:2, in volume). Each separators exhibited different wettability in different solvent systems.

The separators having polyethylene (PE), polypropylene (PP), or polyethylene terephthalate (PET) as the major component had poor wettability toward the polar solvents such as γ-butyrolactone (GBL), 1-methyl-2-pyrrolidinone (NMP), and propylene carbonate (PC), but they had better wettability toward the non-polar solvents such as dimethylene carbonate (DMC) and diethylene carbonate (DEC).

However, the hyper-branched polymer had good wettability toward the polar solvents such as γ-butyrolactone (GBL), 1-methyl-2-pyrrolidinone (NMP), and propylene carbonate (PC). Therefore, the separator of PE, PP, or PET modified by the hyper-branched polymer had good wettability toward the solvent systems such as EC/PC/DEC (3:2:5, in volume) and EC/PC/DEC (2:1:2, in volume).

Due to the repellency of the hyper-branched polymer towards DEC, when the lithium ions were driven to pass through the separator, the DEC molecules surrounding the lithium ions were rejected from passing through the separator. Therefore, the overall volume of the solvated lithium ions became smaller and the resistance of the ion transportation was reduced. The ion transportation in the battery was improved. As a result, the secondary battery having the separator with the hyper-branched polymer had a faster charging and discharging rate.

### Example 8

A lithium nickel cobalt manganese anode plate, a commercial graphite cathode plate MCMB 2528 (Osaka Gas Co., Japan), and the modified porous separator containing the hyper-branched polymer made in Example 5 were rolled to form a jelly roll. The jelly roll was combined with an aluminum shell to form a 503759 battery (thickness: 0.5 cm; width: 3.7 cm; length: 5.0 cm). Three sides of the battery were sealed (sealing condition: 4.0 kgf/cm², 180° C./3 s) and one side was left open. Electrolyte for a standard lithium battery (1.1M LiPF₆/EC+PC+DEC, wherein EC: PC: DEC=3:2:5 (vol)) was poured into the battery from the opening side. Then, the opening side was sealed (sealing condition: 4.0 kgf/cm², 180° C./3 s) after air was exhausted from the battery. The amount of the electrolyte in the battery was 4.2 g/per battery. Finally, a standard formation procedure was performed to activate the lithium battery, thus providing the lithium battery sample.

The lithium battery was tested for a 6 C/30V voltage discharging test. After the test, the anode plate was taken out and tested for SEM/EDX composition analyzation. The results are shown below. The anode plate with the separator containing the hyper-branched polymer inhibited the anode material from forming and releasing oxygen.

| | | Initial rate of oxygen to | Final rate of oxygen to |
|---|---|---|---|
| | | nickel cobalt manganese | nickel cobalt manganese |
| | Anode with a separator | inside the anode material | inside the anode material |
| Comparative | Unmodified | 1.4%-4.0% | 1.2%-1.5% |
| example | | | |
| Example | Modified | 4.3%-4.8% | 3.8%-4.3% |

### Example 9

Free volume of the material was tested by Positron Annihilation Lifetime Spectroscopy (PAS) at various temperatures. The hyper-branched polymer—a solution in Example 1 was slowly dripped into a solvent system of acetone/methanol (1:1, vol), thus forming fine particles of the hyper-branched polymer. A 0.2 μm PTFT of filter film was used to filter the solution, and the remaining solid on the filter film was dried in a vacuum oven at 60° C. The obtained solid powder was the hyper-branched polymer.

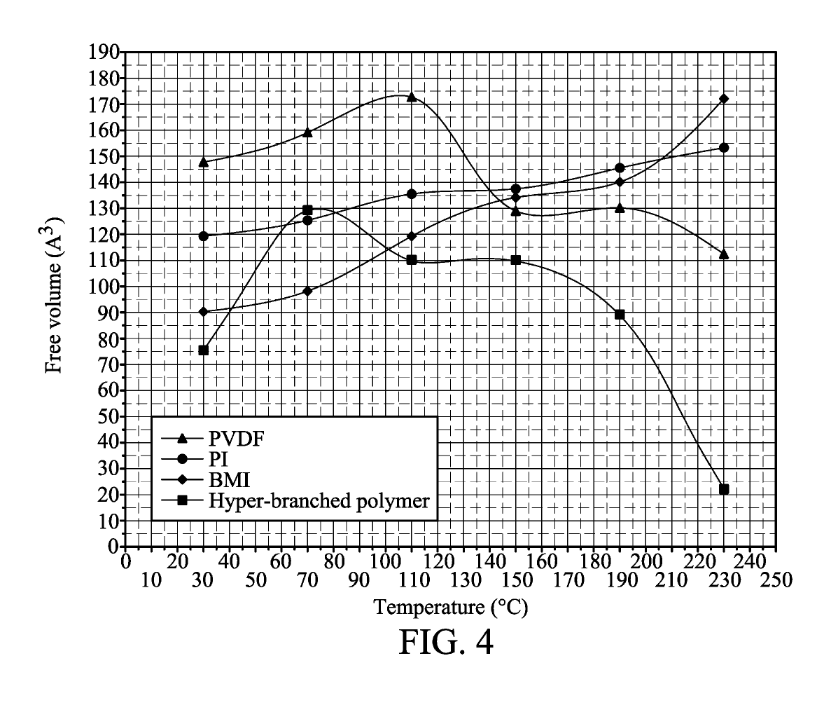

The hyper-branched polymer, its monomer set BMI (N-N′-4,4′-diphenylmethylbismaleimide; Aldrich), a commercial available DuPont PI film (DuPont Kapton Film, with a thickness of 25 μm), and a polyvinyladene fluoride (PVDF; Atofina) film were tested for PAS (radioactive source: ²²Na) respectively at various temperatures. The detection temperatures were 30° C., 70° C., 110° C., 150° C., 190° C., and 230° C. Free volume of the material described above was detected at different temperatures, and the results are shown in FIG. 4.

FIG. 4 illustrates the free volume radius of the hyper-branched polymer at different temperatures. As shown in FIG. 4, the free volume radius of the hyper-branched polymer was about 2.63 Å at room temperature. When the temperature was at about 70° C., the free volume radius of the hyper-branched polymer was about 3.14 Å. When the temperature was at about 150° C., the free volume radius of the hyper-branched polymer was about 2.97 Å. When the temperature was at about 190° C., the free volume radius of the hyper-branched polymer was about 2.78 Å. When the temperature was at about 230° C., the free volume radius of the hyper-branched polymer was about 1.73 Å.

Polyimide (PI) is a linear polymer, and its free volume increased when the temperature increased, as expected. PVDF was a commonly used porous structure material as a binder of electrodes and conductive material. PVDF can usually work for a long time at a temperature of 150° C. As shown in FIG. 4, PVDF can be used at 150° C. after an annealing process at 110° C. to 150° C. However, although the free volume of PVDF shrunk at a temperature of 110° C. to 230° C., pores of PVDF film was not small enough to block the solvated lithium ion transportation. Therefore, compared with PVDF, the hyper-branched polymer was safer and underwent a thermal mechanism that was more beneficial for a lithium battery.

As shown in FIG. 4, when the temperature increased, free volumes of common polymer materials also increased due to turbulence of molecular chains. This is the same with the hyper-branched polymer, wherein the free volume of the hyper-branched polymer increased when the temperature increased. However, when the temperature increased from room temperature to 70° C., the free volume of the hyper-branched polymer reached its maximum size. When the temperature increased to 150° C., the free volume of the hyper-branched polymer shrunk. That is, the hyper-branched polymer started to close its pores, and therefore the ion transportation in the battery was reduced. When the temperature reached 230° C., the free volume of the hyper-branched polymer became so small that solvated lithium ions were not able to pass therethrough. Therefore, the hyper-branched polymer was in the shut down structure that effectively stopped the reaction from continuing.

The conventional separator materials, such as PI, PVDF, or BMI, had a free volume which increased when the temperature increased. Therefore, they did not form a closed-pore structure when the temperature increased.

### Example 10

The hyper-branched polymer-a formed of N-N′-4,4′-diphenylmethylbismaleimide and barbituric acid in Example I was synthesized by various molar ratios. The monomer sets of the specific molar ratio was placed into a PC solvent and stirred until it was fully dissolved. PC had a solid content of 20 wt %. The mixture was heated to 130° C. and continuously stirred for 6 hours. The obtained solution was the hyper-branched polymer solution.

The polymer formed of pure N-N′-4,4′-diphenylmethylbismaleimide had a degree of branching of 0%. The polymer formed of N-N′-4,4′-diphenylmethylbismaleimide and barbituric acid in the molar ratio of 10:1 had a degree of branching of 32%. The polymer formed of N-N′-4,4′-diphenylmethylbismaleimide and barbituric acid in the molar ratio of 5:1 had a degree of branching of 67%. The polymer formed of N-N′-4,4′-diphenylmethylbismaleimide and barbituric acid in the molar ratio of 2:1 had a degree of branching of 84%. The polymer formed of N-N′-4,4′-diphenylmethylbismaleimide and barbituric acid in the molar ratio of 1:1 had a degree of branching of 98%.

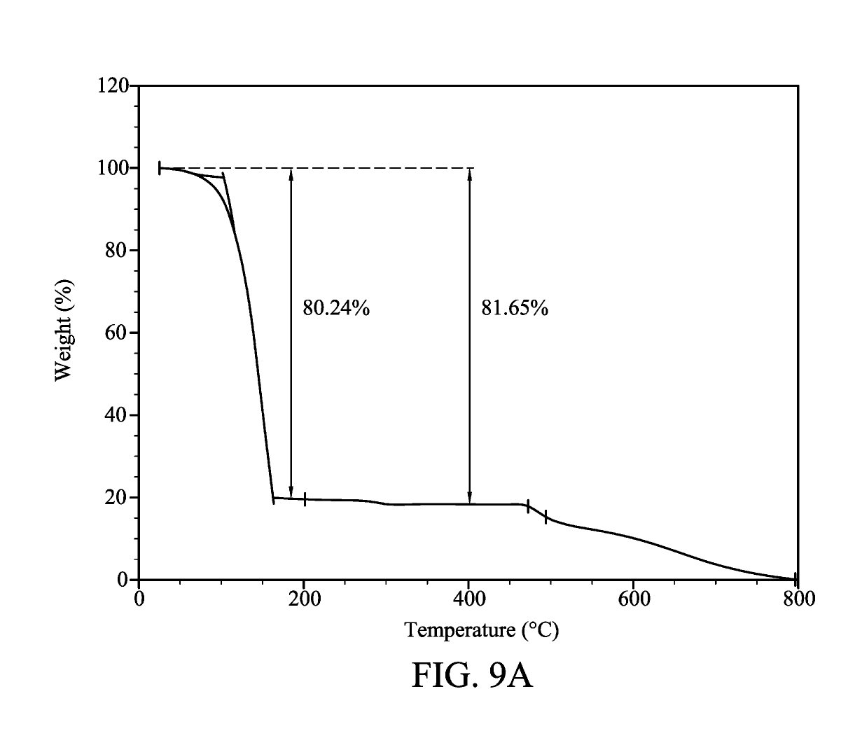

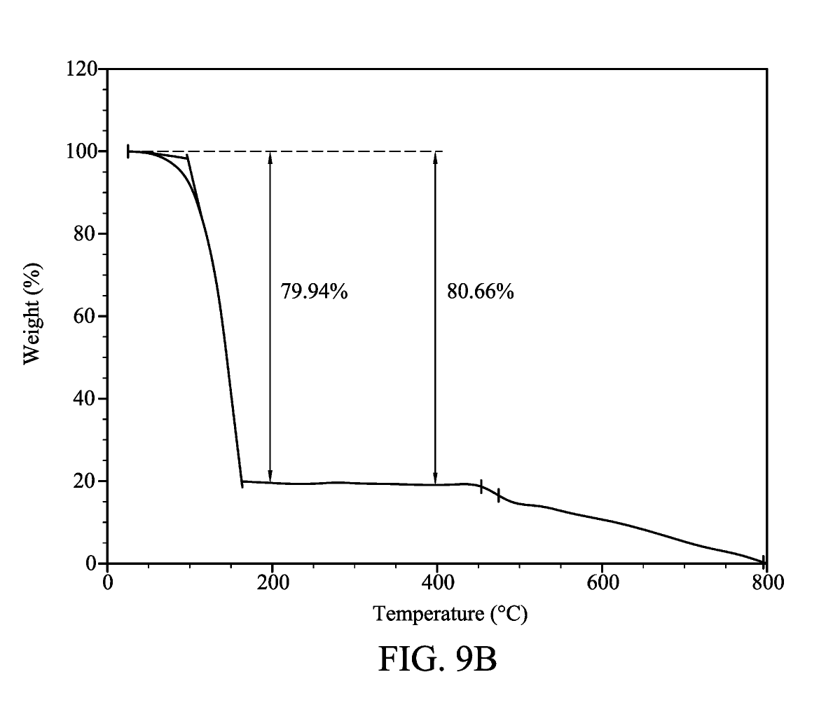

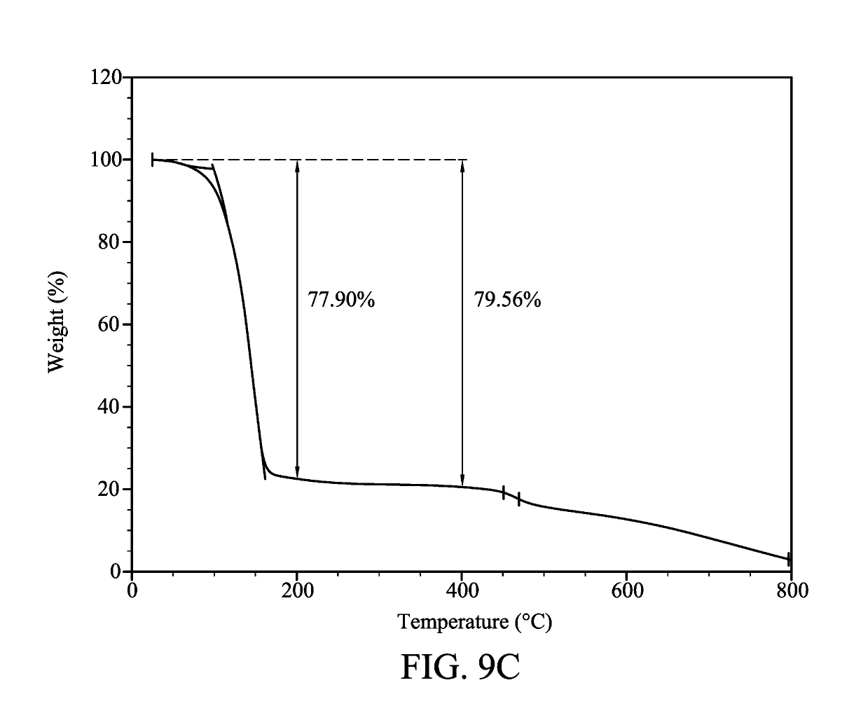

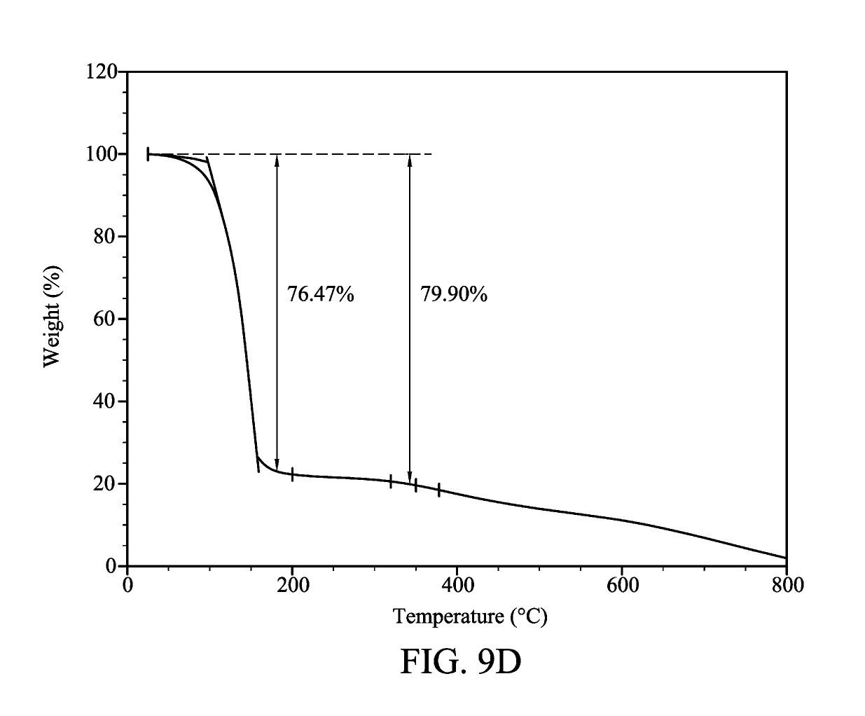

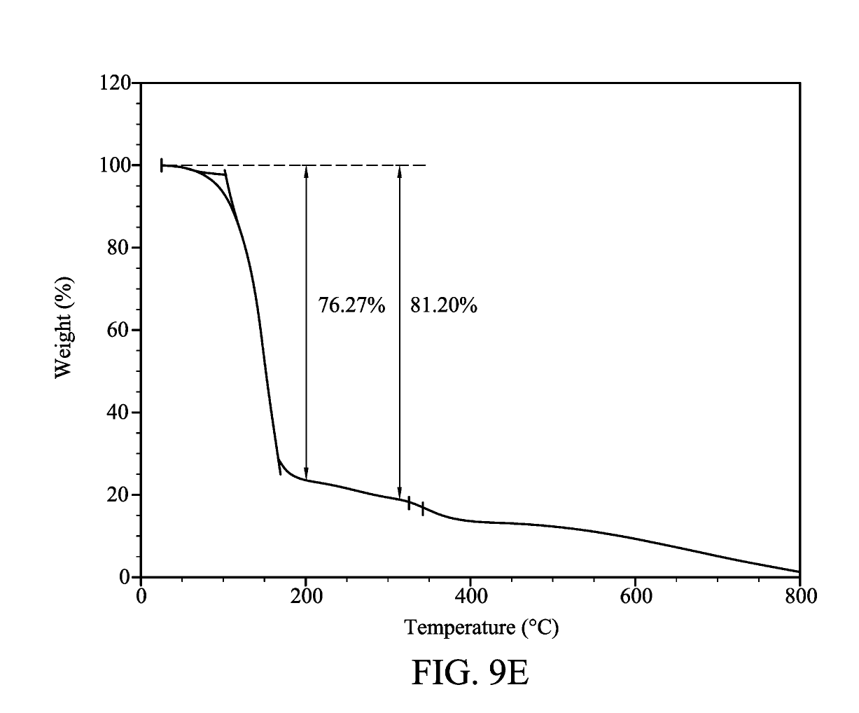

The hyper-branched polymer described above and the monomer set of N-N′-4,4′-diphenylmethylbismaleimide were tested for a Thermal Gravimetric Analysis (TGA) test. The testing temperature was from room temperature to 800° C. under nitrogen (20 ml/min), wherein the temperature ramp-up rate was 10° C./min. If the polymer retained more small molecules such as water or solvent therein, the TGA spectrum showed less lose weight of the polymer. That is, the polymer had better electrolyte retention ability. TGA spectrum illustrated that for the electrolyte retention ability of the hyper-branched polymer, the higher the degree of branching was, the better the electrolyte retention ability the polymer had. The polymer with the degree of branching of 0% (FIG. 9A) had an electrolyte retention ability of 0%. The polymer with the degree of branching of 32% (FIG. 9B) had an electrolyte retention ability of only 0.72%. The polymer with the degree of branching of 67% (FIG. 9C) had an electrolyte retention ability of 1.66%. The polymer described above had the electrolyte retention ability of lower than 2%. However, when the degree of branching of the polymer increased from 67% to 84% (FIG. 9D), its electrolyte retention ability increased from 1.66% to 3.43%. When the degree of branching of the polymer reached 98% (FIG. 9E), its electrolyte retention ability increased to 4.93%.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A battery separator, comprising:
a porous hyper-branched polymer which undergoes a closed-pore mechanism at a field effect condition, wherein the field effect condition includes at least one of a temperature being above 150° C., a voltage being 20V, or a current being 6 A; and
a porous structure material.

2. The battery separator as claimed in claim 1, wherein the porous structure material and the porous hyper-branched polymer are formed as a single film.

3. The battery separator as claimed in claim 1, wherein the porous hyper-branched polymer is a film coated onto the porous structure material.

4. The battery separator as claimed in claim 1, wherein the porous structure material comprises polyethylene, polypropylene, poly(tetrafluoroethylene), polyamide, poly(viny chloride), polyvinylidine fluride, polyaniline, polyimide, nonwoven, polyethylene terephthalate, polystyrene, or combinations thereof.

5. The battery separator as claimed in claim 1, wherein the porous hyper-branched polymer is formed by a reaction of a nitrogen-containing polymer and a diketones-containing compound, wherein the nitrogen-containing polymer comprises amine, amide, imide, maleimides, imine, or combinations thereof, and wherein the diketones-containing compound comprises barbituric acid (BTA).

6. The battery separator as claimed in claim 1, further comprising a binder.

7. The battery separator as claimed in claim 6, wherein the binder comprises polyvinylidene fluoride (PVDF), styrene-butadiene rubber (SBR), polyamide, melamine resin, or combinations thereof.

8. The battery separator as claimed in claim 1, wherein the battery separator has a pore size between about 0.2 nm and 500 nm, and a porosity between about 10% and 80%.

9. The battery separator as claimed in claim 1, wherein pores of the porous hyper-branched polymer start to shrink at a temperature above about 70° C.

10. A method for manufacturing a battery separator, comprising:
providing a porous structure film; and
coating a porous hyper-branched polymer onto the porous structure film to form a battery separator, wherein the battery separator comprises the porous hyper-branched polymer undergoing a closed-pore mechanism at a field effect condition, wherein the field effect condition includes at least one of a temperature being above 150° C., a voltage being 20V, or a current being 6 A.

11. The method for manufacturing a battery separator as claimed in claim 10, wherein the porous structure film comprises polyethylene, polypropylene, poly(tetrafluoroethylene), polyamide, poly(viny chloride), polyvinylidine fluride, polyaniline, polyimide, nonwoven, polyethylene terephthalate, polystyrene, or combinations thereof.

12. The method for manufacturing a battery separator as claimed in claim 10, wherein the porous hyper-branched polymer is formed by a reaction of a nitrogen-containing polymer and a diketones-containing compound, wherein the nitrogen-containing polymer comprises amine, amide, imide, maleimides, imine, or combinations thereof, and wherein the diketones-containing compound comprises barbituric acid (BTA).

13. The method for manufacturing a battery separator as claimed in claim 10, further comprising before coating the porous hyper-branched polymer onto the porous structure film, surface modifying the porous structure film by alkalizing or plasma.

14. The method for manufacturing a battery separator as claimed in claim 10, further comprising before coating the porous hyper-branched polymer onto the porous structure film, surface modifying the porous hyper-branched polymer film by alkalizing or plasma.

15. The method for manufacturing a battery separator as claimed in claim 10, further comprising mixing the hyper-branched polymer with a binder before coating the porous hyper-branched polymer onto the porous structure film.

16. A method for manufacturing a battery separator, comprising:
mixing a porous structure material and a porous hyper-branched polymer to form a mixture; and
subjecting the mixture to a dry or wet process to form a battery separator, wherein the battery separator comprises the porous hyper-branched polymer undergoing a closed-pore mechanism at a field effect condition, wherein the field effect condition includes at least one of a temperature being above 150° C., a voltage being 20V, or a current being 6 A.

17. The method for manufacturing a battery separator as claimed in claim 16, wherein the porous structure material comprises polyethylene, polypropylene, poly(tetrafluoroethylene), polyamide, poly(viny chloride), polyvinylidine fluride, polyaniline, polyimide, nonwoven, polyethylene terephthalate, polystyrene, or combinations thereof.

18. The method for manufacturing a battery separator as claimed in claim 16, wherein the porous hyper-branched polymer is formed by a reaction of a nitrogen-containing polymer and a diketones-containing compound, wherein the nitrogen-containing polymer comprises amine, amide, imide, maleimides, imine, or combinations thereof, and wherein the diketones-containing compound comprises barbituric acid (BTA).

19. The method for manufacturing a battery separator as claimed in claim 16, further comprising before mixing the porous structure material and the porous hyper-branched polymer, surface modifying the porous structure material by alkalizing or a plasma.

20. The method for manufacturing a battery separator as claimed in claim 16, further comprising before mixing the porous structure material and the porous hyper-branched polymer, surface modifying the porous hyper-branched polymer by alkalizing or a plasma.

21. The method for manufacturing a battery separator as claimed in claim 16, further comprising mixing the porous hyper-branched polymer, the porous structure material, and a binder before subjecting the mixture to the dry or wet process.

22. A secondary battery, comprising:
a cathode and an anode;
an electrolyte between the cathode and the anode; and
a battery separator as claim in claim 1 disposed between the cathode and the anode to separate the cathode and the anode.
